(19) United States
(12) Patent Application Publication
(10) Pub. No.: US 2019/0110163 A1
(43) Pub. Date: Apr. 11, 2019

(54) SYSTEM AND METHOD FOR GENERATING AND SCHEDULING MATCHES AND MEETUPS BASED ON LOGISTICAL DATA

(71) Applicant: Eve Caroline Peters, San Francisco, CA (US)

(72) Inventor: Eve Caroline Peters, San Francisco, CA (US)

(21) Appl. No.: 16/157,792

(22) Filed: Oct. 11, 2018

Related U.S. Application Data
(60) Provisional application No. 62/570,967, filed on Oct. 11, 2017.

(51) Int. Cl. H04W 4/02; G06F 17/30; G06Q 10/10; H04W 8/18; G06F 3/0484; H04W 8/00

(52) U.S. Cl. CPC H04W 4/023; G06F 17/30876; H04W 8/005; H04W 8/18; G06F 3/0484; G06Q 10/1095

(57) ABSTRACT

The present invention generally relates to a system and method for generating and scheduling matches and meetups based on logistical data. In particular, embodiments of the present invention are directed to providing systems and methods for matching users based on compatible preferences and mutual selection, and further generating meetups based on mutual availability and geographic location, providing a simplified process for connecting users without requiring manual analysis and scheduling.

### CROSS-REFERENCE TO RELATED APPLICATIONS

This application claims the benefit of U.S. Provisional Application No. 62/570,967 filed on Oct. 11, 2017, the entire disclosure of which is hereby incorporated by reference in its entirety.

### FIELD OF THE INVENTION

The present invention generally relates to a system and method for generating and scheduling matches and meetups based on logistical data. In particular, embodiments of the present invention are directed to providing systems and methods for matching users based on compatible preferences and mutual selection, and further generating meetups based on mutual availability and geographic location, providing a simplified process for connecting users without requiring manual analysis and scheduling.

### BRIEF DESCRIPTION OF THE DRAWINGS

FIG. 1 illustrates an exemplary process flow for generating and scheduling matches and meetups based on logistical data;

FIG. 2 illustrates an exemplary process flow for generating and scheduling matches and meetups based on logistical data;

FIG. 3 illustrates an exemplary process flow for generating and scheduling matches and meetups based on logistical data;

FIG. 4 illustrates a schematic overview of a computing device, in accordance with an embodiment of the present invention;

FIG. 5 illustrates a schematic overview of an embodiment of a system for generating and scheduling matches and meetups based on logistical data;

FIG. 6 illustrates a schematic overview of an embodiment of a system for generating and scheduling matches and meetups based on logistical data;

FIG. 7 is an illustration of a network diagram for a cloud based portion of the system, in accordance with an embodiment of the present invention; and

FIG. 8 is an illustration of a network diagram for a cloud based portion of the system, in accordance with an embodiment of the present invention.

### DETAILED DESCRIPTION

The present invention generally relates to a system and method for generating and scheduling matches and meetups based on logistical data. In particular, embodiments of the present invention are directed to providing systems and methods for matching users based on compatible preferences and mutual selection, and further generating meetups based on mutual availability and geographic location, providing a simplified process for connecting users without requiring manual analysis and scheduling.

According to an embodiment of the present invention, the system may be configured to replace text-based chatting, traditionally used by matched users in order to set a date and location for meeting. In preferred embodiments of the present invention, the system may engage with scheduling applications and location based services (LBS) modules in order to automate and generate real-time (for example, same day) meetups (for example, dates) for users. In still further embodiments, the system may be configured to allow for automation and generation of future meetups for users, based on scheduling and location availability at identified times in the future. One of ordinary skill in the art may appreciate that the system may be configured to automate and generate meetups for users based on availability and location across any window or period of time, whether the availability is immediate or any time in the future, and embodiments of the present invention may be contemplated for use with any such automation and generation of meetups.

In certain embodiments, the scheduling applications may be integrated within the system. In other embodiments, scheduling information and data may be retrieved from one or more third party systems (for example, remote calendaring applications). One of ordinary skill in the art may appreciate that there are numerous manners in which the scheduling information may be incorporated in the system or retrieved from remote calendaring applications (for example, via one or more application programming interfaces (APIs)), and embodiments of the present invention may be contemplated for use with any appropriate configuration of such information and data elements.

In certain embodiments, the LBS modules may be integrated within the system. In other embodiments, LBS information may be retrieved from one or more third party systems (for example, remote geographic data providers). One of ordinary skill in the art may appreciate that there are numerous manners in which the LBS information may be incorporated in the system or retrieved from remote LBS systems (for example, via one or more application programming interfaces (APIs)), and embodiments of the present invention may be contemplated for use with any appropriate configuration of such information and data elements.

According to an embodiment of the present invention, the system may accomplish the matching of users based on each user's profile characteristics (for example, age, gender, interests, physical characteristics, common friends, social media connections, hobbies, profession, education, location, and the like). One of ordinary skill in the art may appreciate that there are numerous profile characteristics that users may be matched on, and embodiments of the present invention may be contemplated for use with any appropriate profile characteristics.

In preferred embodiments, the system may be configured to identify potential matches for various users based on one or more profile characteristics, and present users who may be potential matches to one another for verification. Users may verify or otherwise confirm interest in one another user by approving a match proposed by the system. One of ordinary skill in the art may appreciate that there are numerous methods for presenting and verifying user matches, and embodiments of the present invention may be contemplated for use with any appropriate means and methods for presenting and verifying user matches.

According to an embodiment of the present invention, the system may accomplish the scheduling of meetups with users by collecting each user's availability information (for example, date, time, location, and the like), and use that information to create a pairing of matched users as well as provide them with information regarding where and when they should meet up. In preferred embodiments of the present invention, the system may be configured to automatically retrieve stored user availability for matched users and identify and generate meetups for matched users. For example, in a preferred embodiment, the system may identify open scheduling availability for two users, wherein the open scheduling availability is an adequate period of time (for example, 1 hour) that is not otherwise committed in the schedule of such users to other activities.

Further, in preferred embodiments of the present invention, the system may augment the scheduling availability criteria with location information. For instance, the system may be configured to only generate meetups for those users that not only have matching scheduling availability, but also have such availability in a defined geographic area. Thereby, both users may not only be required to have scheduling availability, but also matching geographic availability. For instance, geographic availability may be limited to a radius from an identified area, set by a user (for example, within 1-mile radius from present location, within 2-mile radius from home, within 3-mile radius of work location). In other embodiments, radius may not be the defining unit for geographic availability. Other potential usable criteria may include, but are not limited to, zip code, city, neighborhood (for example, Bowery, East Village, SoHo, Midtown, Tribeca), or any combination thereof. In still further embodiments, the system may be configured to allow for users to submit location exclusions as part of their geographic availability information (for example, meeting in Brooklyn, except for Bedford Stuyvesant area; meeting in Midtown, except for Times Square area). One of ordinary skill in the art may appreciate that there are numerous geographic availability (and exclusion) criteria that may be utilized with embodiments of the present invention, and embodiments of the present invention are contemplated for use with any appropriate geographic availability criteria.

In such preferred embodiments, the system may be configured to replace text based, peer-to-peer, or other manual forms of communication regarding the availability and location of users for the purpose of creating a meetup. As such, the system may be able to provide users, through one or more graphical user interfaces (GUI), the ability to communicate the same information more efficiently, without the need for manual interaction. In preferred embodiments, through the GUI, users may inform the system about their availability and location (instead of informing each other through text-based communications). In other embodiments, the system may be able to retrieve availability and/or location from other data sources (for example, calendar applications, global positioning systems, and the like) and use this data to process appropriate matching automatically for users.

According to an embodiment of the present invention, the system may parse all of the availability, location, and mutual liking data of the user base to create date pairings (“matches”) for sets of users (for example, 2 users), based on the satisfaction of criteria. In a preferred embodiment, three criteria may be optimally used to create such pairings: 1) mutual availability to meet on the same date; 2) overlapping geographical regions of availability where they may meet; and 3) mutual selection/liking of each other based on profile characteristics or other data. According to an embodiment of the present invention, the system may be configured to provide a user interface (UI) and/or user experience (UX) that applies a method/process that enables these criteria to be satisfied asynchronously and in any order.

According to an embodiment of the present invention, the system may be configured to create match/date pairings via satisfaction of overlapping availability and location criteria. For example, in a preferred embodiment of the present invention, the system may allow for: a first user to set availability to meetup with other users; the first user may then like one or more other user(s) (this may be before or after providing availability), creating a match; allowing for a second user to set their availability; wherein at that point, the system, which may be continuously generating checks for matches, may note that the first and second users are available in an overlapping region, and the first and second users have matched with one another. At this point, the system may be configured to create a meetup based on satisfaction of: 1) Mutual availability; 2) Availability in the overlapping region; and 3) Mutual liking/selection. For instance, two users who set availability for the same night, in respective locations with an overlapping area, and who mutually liked each other, qualify for a meetup.

According to an embodiment of the present invention, the system may be configured to update availability and geographic locations in real time or near real time, such that users that have matched on profile characteristics may later match on temporal availability and overlapping geographic locations at a time in the future when those matches occur.

Further, in certain embodiments of the present invention, the system may be configured to not only match users for a meetup location, but also reserve or otherwise create events based on the user's information. For instance, the system may be configured to use the scheduling and location information to identify a restaurant in the location, with available tables at the time of the meetup, and make reservations for the users on their behalf. Further, embodiments of the present invention may be configured to take into consideration profile characteristics when making such reservations or events. For example, if the first and second user both indicated they like Italian food, the system may attempt to reserve a table at an Italian restaurant in the identified location. Or if the first and second users are fans of a sport, musical act, or other identifiable subject, the system may book tickets for an event involving the identifiable subject on behalf of the first and second user. One of ordinary skill in the art may appreciate that there are numerous profile characteristics that may be utilized by the system to identify appropriate events or reservation types that may be made based on such profile characteristics.

In still further embodiments, the system may be configured to provide matches of users based solely, or at least initially, on availability and/or geographic location. In this manner, users may be matched based on their physical location and availability at specific times, and not based on prior matching on profile characteristics or other characteristics. In this manner, the system may act more like an automated “blind date” matching system, connecting two or more users based on availability alone, without the users first getting to know much about the other user. In certain embodiments, the system may be configured to first match these users based on location and availability, but then, prior to scheduling a meetup, requesting that the users confirm the match, based on their profile characteristics. In still further embodiments, the system may match users based on their location and availability, but also limit these matches to those users who also share at least a portion of appropriate profile characteristics. For example, the system may match a first user who is looking for a man between the ages of 25-35, at least 5′11″, college educated, no children, and of a specified religion, with a second user that matches greater than a given percentage of those characteristics (for example, 75%). One of ordinary skill in the art may appreciate that there are numerous ways to match users based on profile characteristics, and embodiments of the present invention may be contemplated for use with any such methods.

In still further embodiments, the system may be configured to notify, en masse, a first user's matches regarding the first user's scheduling/logistical data. Specifically, when the first user indicates availability in a particular area, a notification may be sent to the first user's matches. For example, the notification may say “Your match is free tonight! Act fast to snag a date.” A notified user may log on and entering scheduling/logistical data, indicating that the match is also available within a particular radius. On a condition that the radii of availability overlap, a date may be scheduled.

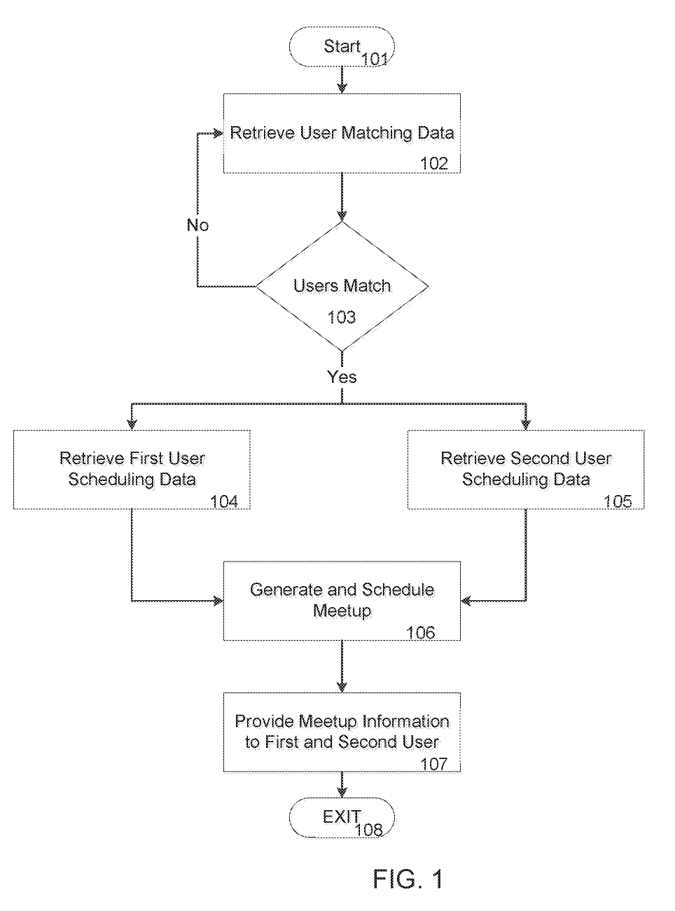

Turning now to FIG. 1, an exemplary process flow for generating and scheduling matches and meetups based on logistical data, in accordance with an embodiment of the present invention, may be described herein. The process starts at step 101 with the system being engaged to generate matches between users. At step 102, the system may retrieve all (or a subset thereof) of matching data associated with users in the system. Matching data in this instance may be based on the matching of a first user and a second user that have matched on profile characteristics (for example, “liked” one another) and also have corresponding location and schedule overlaps.

If there are no matches to process (Decision 103), the system may continue to loop through the process until there is an available match to process. If there is a match between a first and second user, then the system may proceed.

At step 104, the system may retrieve scheduling data associated with a first user. Scheduling data may generally comprise information related to the availability of a first user to attend a meetup with another user over a given time period (for example, a day, a week, a month, or the like). As noted elsewhere herein, the system may retrieve scheduling data from local data stores, or from remote data stores (for example, retrieved from third-party scheduling/calendaring applications/systems).

At step 105, the system may similarly retrieve scheduling data associated with the second user. At step 106, the system may then review and identify optimal meeting times for the first and second user, based at least in part on their availability information, and the system may generate and schedule a meetup for the first and second user.

At step 107, the system may provide the generated meetup information to the first and second user. At this point, the process may terminate at step 108.

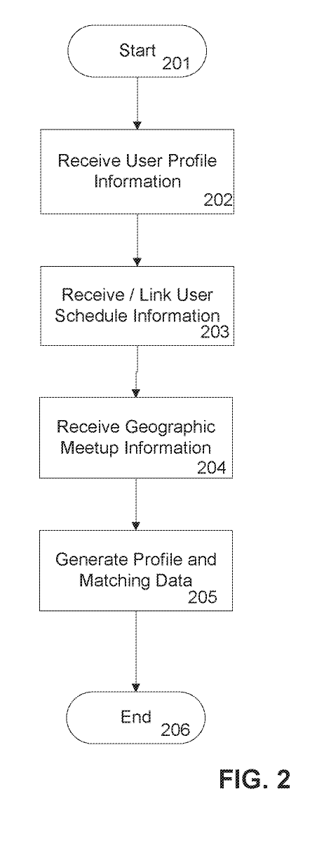

Turning now to FIG. 2, an exemplary process flow for generating and scheduling matches and meetups based on logistical data, in accordance with an embodiment of the present invention, may be described herein. The process starts at step 201 with the system being engaged to generate information related to a user. At step 202, the system may receive user profile information entered by a user. Generally, this may occur when, for instance, a user is creating an account with the system. However, users may have the ability to update their profile information at any time, so the process may be implicated at those times as well.

At step 203, the system may receive or is otherwise provided schedule information. In certain embodiments, the users may enter in their availability to the system. In other embodiments, the user may link the system to an external scheduling system for the provision of availability information.

At step 204, the system may receive geographic meetup information from the user. Users may be given numerous methods to provide this information, including, but not limited to, manual entry, determination of location by Location-Based Services (LBS) (for example, Global Positioning System (GPS), Internet Protocol (IP) address, and the like), or any combination thereof.

At step 205, the system may generate profile and matching data and insert the user into the database of users for matching and pairing with other users. At this point, the process may terminate at step 206.

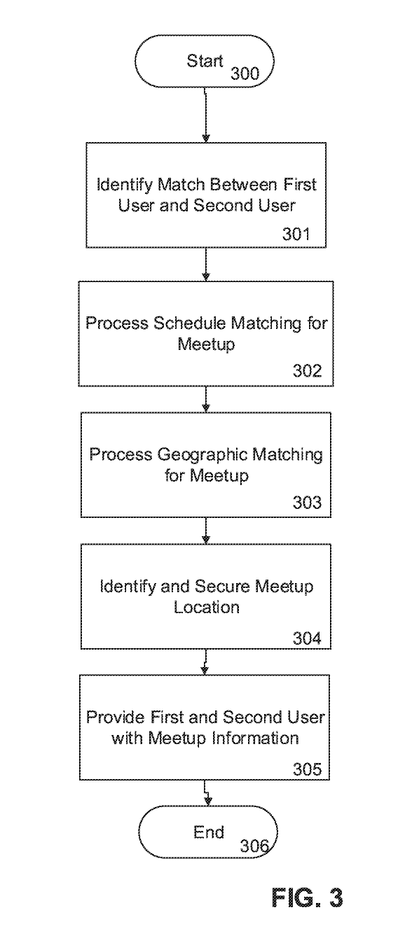

Turning now to FIG. 3, an exemplary process flow for generating and scheduling matches and meetups based on logistical data, in accordance with an embodiment of the present invention, may be described herein. The process starts at step 300 with the system being engaged to generate matches between users. At step 301, the system may identify a match between a first and second user. At this point, the system may have determined that a first and a second user have indicated interest in one another (for example, “liked” one another), and that the first and second user may have matching availability and location overlap.

At step 302, the system may process the availability for the first and second user and determines an optimal meetup time for the users. In certain embodiments, the system may account for availability criteria, such as average length of a meetup (for example, based on certain criteria, such as location, event type, or other available criteria), total availability overlap between first and second user, end of availability for each user, or any combination thereof. Ideally, the system may generate a meetup that allowed for an optimized amount of time for the users, such that a meetup may not be cut short, for instance, by way of the end of available time.

At step 303, the system may process the geographic matching area for the meetup. With the geographic location information from both the first and second user, the system may be able to identify and process the overlapping area for the possible meetup between the users.

At step 304, the system may identify an optimal meetup location (for example, a restaurant, a coffee shop, a bar, or the like) for the meetup. In preferred embodiments, the system may identify availability and secure reservations for the users for the identified meetup time.

At step 305, the system may provide the information to the users. At this point, the process may terminate at step 306.

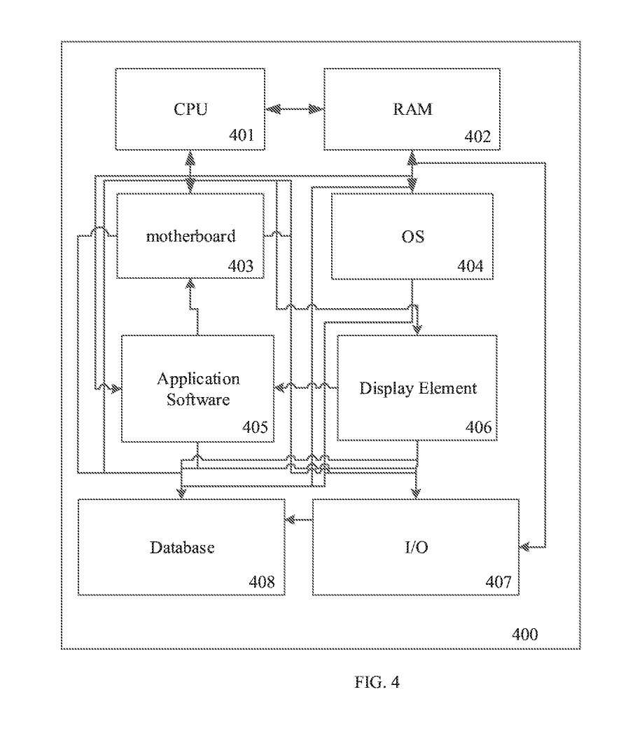

Turning now to FIG. 4, a schematic overview of a computing device, in accordance with an embodiment of the present invention, may be described herein. As shown in FIG. 4, One of ordinary skill in the art may appreciate that a computing device 400 appropriate for use with embodiments of the present application may generally be comprised of one or more of a Central processing Unit (CPU) 401, Random Access Memory (RAM) 402, a storage medium (for example, hard disk drive, solid state drive, flash memory, cloud storage) 403, an operating system (OS) 404, one or more application software 405, one or more display elements 406, one or more input/output devices/means 407 and one or more databases 408. Examples of computing devices usable with embodiments of the present invention may include, but are not limited to, personal computers, smartphones, laptops, mobile computing devices and tablet PCs. Certain computing devices configured for use with the system may not need all the components described in FIG. 4. The term computing device may also describe two or more computing devices communicatively linked in a manner as to distribute and share one or more resources, such as clustered computing devices and server banks/farms. One of ordinary skill in the art may understand that any number of computing devices may be used, and embodiments of the present invention may be contemplated for use with any computing device.

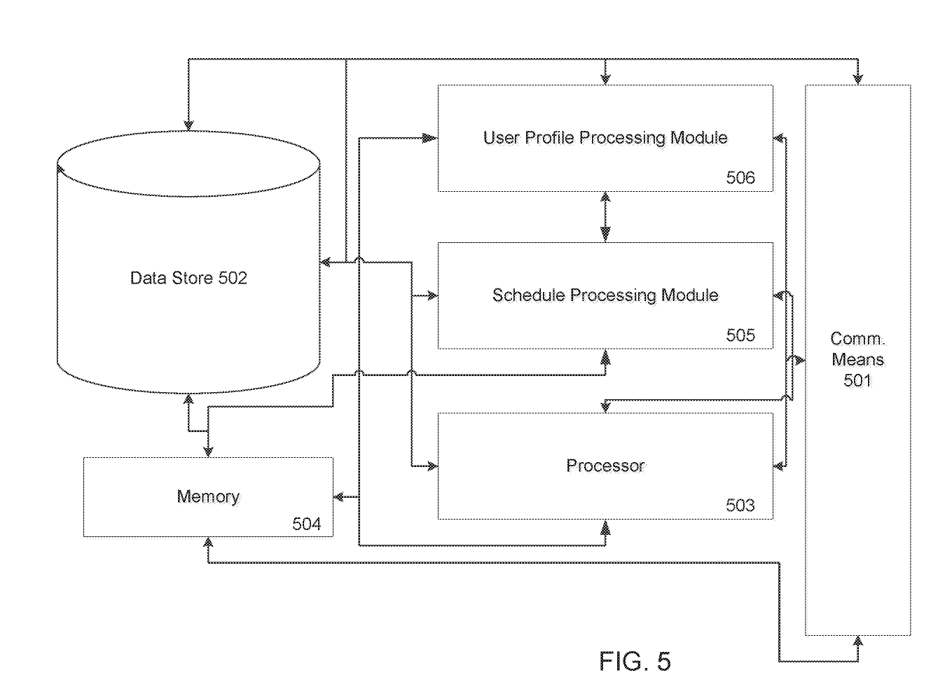

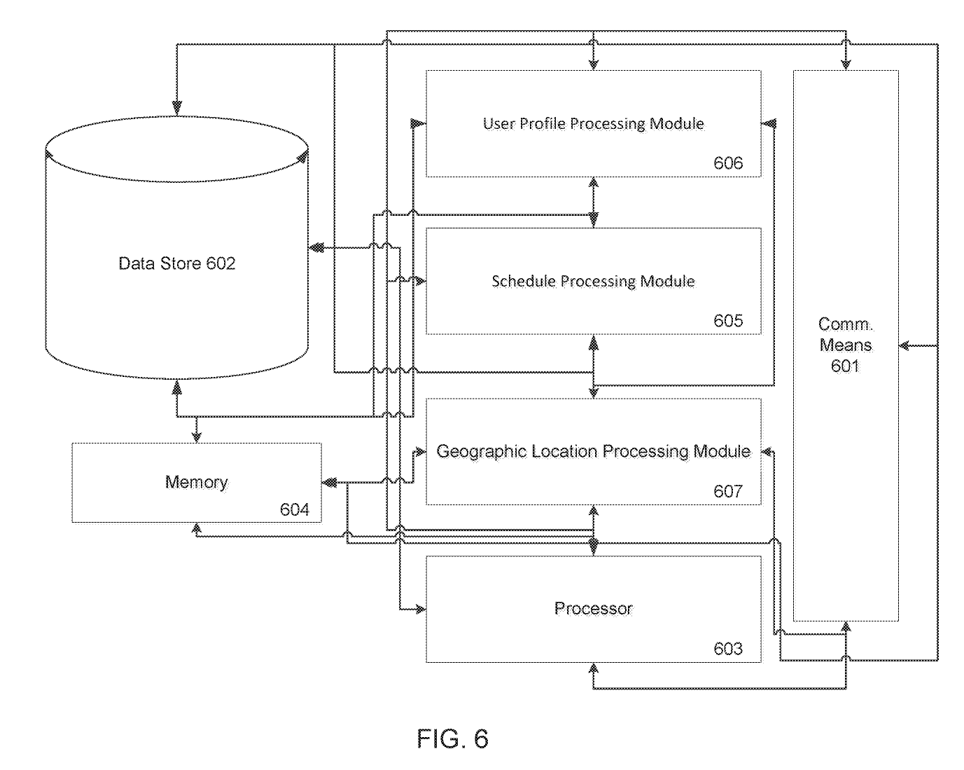

Turning to FIG. 5, according to an embodiment of the present invention, a system for an eBook reader application implementing 3d graphical user interfaces and interactions may be comprised of one or more communications means 501, one or more data stores 502, a processor 503, memory 504, a schedule processing module 505 and a user profile processing module 506. FIG. 6 shows an alternative embodiment of the present invention, comprised of one or more communications means 601, one or more data stores 602, a processor 603, memory 604, a schedule processing module 605, a user profile processing module 606 and a geographic location processing module 607. The various modules described herein may provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

Throughout this disclosure and elsewhere, block diagrams and flowchart illustrations depict methods, apparatuses (for example, systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) may be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It may be understood that an embodiment may contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

In an exemplary embodiment according to the present invention, data may be provided to the system, stored by the system and provided by the system to users of the system across local area networks (LANs) (for example, office networks, home networks) or wide area networks (WANs) (for example, the Internet). In accordance with the previous embodiment, the system may be comprised of numerous servers communicatively connected across one or more LANs and/or WANs. One of ordinary skill in the art would appreciate that there are numerous manners in which the system may be configured and embodiments of the present invention are contemplated for use with any configuration.

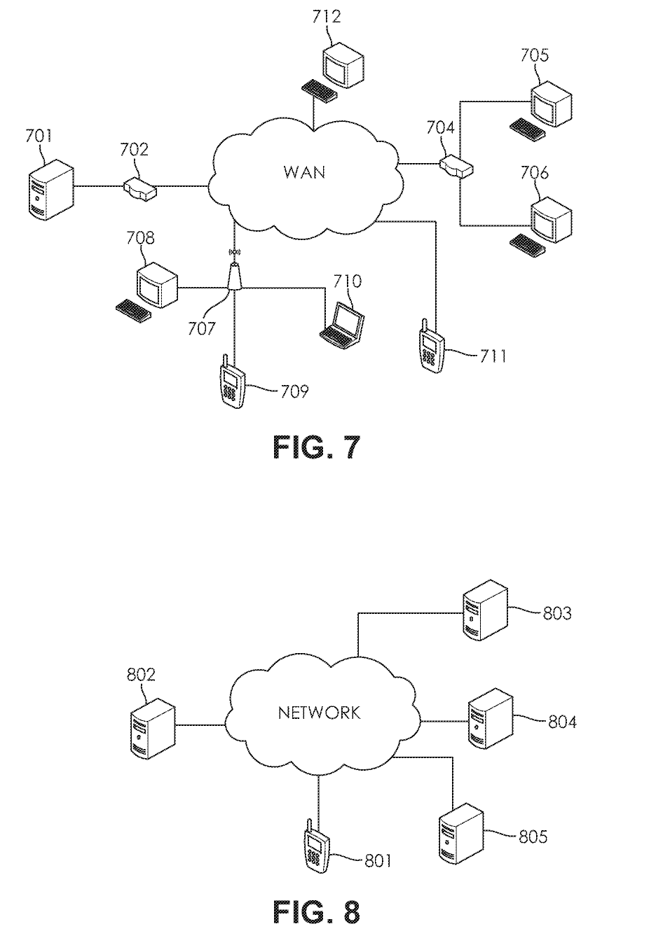

Referring to FIG. 7, a schematic overview of a cloud based system that interacts with the system is shown. The cloud based system is comprised of one or more application servers 703 for electronically storing information used by the system. Applications in the application server 203 may retrieve and manipulate information in storage devices and exchange information through a Network 701 (for example, the Internet, a LAN, WiFi, Bluetooth, and the like). Applications in server 703 may also be used to manipulate information stored remotely and process and analyze data stored remotely across a Network 701 (for example, the Internet, a LAN, WiFi, Bluetooth, and the like).

According to an exemplary embodiment, as shown in FIG. 7, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art would appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (for example, CDMA, GMS, 3G, 4G) to the Network 701. One of ordinary skill in the art would appreciate that there are numerous ways that a component may connect to server 703 via Network 701, and embodiments of the present invention are contemplated for use with any method for connecting to server 703 via Network 701. Furthermore, server 703 may be comprised of a personal computing device, such as a smartphone, acting as a host for other computing devices to connect to.

Turning now to FIG. 8, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a scheduling data service 804, one or more additional geographic data services 805 or any combination thereof. Additionally, application server 802 may be able to enhance or otherwise provide additional services to an external content provider API/website or other third party system 803, a scheduling data service 804, one or more additional geographic data services 805 by providing information to those entities that is stored on a database that is connected to the application server 802. One of ordinary skill in the art would appreciate how accessing one or more third-party systems may augment the ability of the system described herein, and embodiments of the present invention are contemplated for use with any third-party system.

Traditionally, a computer program consists of a finite sequence of computational instructions or program instructions. It may be appreciated that a programmable apparatus (for example, a computing device) may receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which may be suitably employed or configured to process computer program instructions, execute computer logic, store computer data, and so on. Throughout this disclosure and elsewhere a computer may include any and all suitable combinations of at least one general purpose computer, special-purpose computer, programmable data processing apparatus, processor, processor architecture, and so on.

It may be understood that a computer may include a computer-readable storage medium and that this medium may be internal or external, removable and replaceable, or fixed. It may also be understood that a computer may include a Basic Input/Output System (BIOS), firmware, an operating system, a database, or the like, that may include, interface with, or support the software and hardware described herein.

Embodiments of the system as described herein are not limited to applications involving conventional computer programs or programmable apparatuses that run them. It is contemplated, for example, that embodiments of the invention as claimed herein may include an optical computer, quantum computer, analog computer, or the like.

Regardless of the type of computer program or computer involved, a computer program may be loaded onto a computer to produce a particular machine that may perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Computer program instructions may be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it may now be appreciated that elements of the block diagrams and flowchart illustrations support combinations of means for performing the specified functions, combinations of steps for performing the specified functions, program instruction means for performing the specified functions, and so on.

It may be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions may be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread may spawn other threads, which may themselves have assigned priorities associated with them. In some embodiments, a computer may process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like may suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems may be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described may be utilized and presented in a multitude of languages. Individual systems may be presented in one or more languages and the language may be changed with ease at any point in the process or methods described above. One of ordinary skill in the art would appreciate that there are numerous languages the system may be provided in, and embodiments of the present invention are contemplated for use with any language.

While multiple embodiments are disclosed, still other embodiments of the present invention may become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed:

1. A method for generating and scheduling matches and meetups, the method comprising:
retrieving matching data associated with a first user and a second user;
retrieving scheduling data associated with the first user, on a condition that a match is made between the first user and the second user based on the retrieved matching data;
retrieving scheduling data associated with the second user;
identifying a meetup time and place based on the associated scheduling data of the first and second user; and
scheduling a meetup for the first and second user.

2. The method of claim 1, wherein the scheduling data associated with the first and second user is entered in by the first and second user.

3. The method of claim 1, wherein the matching data associated with the first and second user is based on a user profile.

4. The method of claim 3, wherein the user profile includes geographic meetup information.

5. The method of claim 4, wherein the geographic meetup information is determined by location-based services (LBS).

6. The method of claim 1 further comprising:
retrieving geographic meetup information associated with the first and second user;
identifying a meetup location based on the geographic meetup information of the first and second user; and
scheduling a meetup time and location for the first and second user.

7. The method of claim 1, wherein the meetup time is optimal for both the first and second user.

8. The method of claim 1, wherein the meetup accounts for availability criteria.

9. The method of claim 6, wherein the meetup location is an overlap of the geographic meetup information associated with the first and second user.

10. The method of claim 3, wherein the user profile includes a list of preferred activities.

11. A system for generating and scheduling matches and meetups, the system comprising:
a processor receives matching data associated with a first user and a second user from a user profile processing module;
the processor receives scheduling data associated with the first user, on a condition that a match is made between the first user and the second user based on the retrieved matching data;
the processor receives scheduling data associated with the second user;
the processor identifies a meetup time and place based on the associated scheduling data of the first and second user; and
a scheduling processor schedules a meetup for the first and second user.

12. The system of claim 11, wherein the scheduling data associated with the first and second user is entered in by the first and second user.

13. The system of claim 11, wherein the matching data associated with the first and second user is based on a user profile.

14. The system of claim 13, wherein the user profile includes geographic meetup information.

15. The system of claim 14, wherein the geographic meetup information is determined by location-based services (LBS).

16. The system of claim 11 further comprising:
the processor further receives geographic meetup information associated with the first and second user;
the processor further identifies a meetup location based on the geographic meetup information of the first and second user; and
the scheduling processor schedules a meetup time and location for the first and second user.

17. The system of claim 11, wherein the meetup time is optimal for both the first and second user.

18. The system of claim 11, wherein the meetup accounts for availability criteria.
